(19) United States
(12) Patent Application Publication
(10) Pub. No.: US 2024/0149623 A1
(43) Pub. Date: May 9, 2024

(54) MOBILE READER USING 2.4G SIGNAL ENCODING FOR WAKING UP TIRE PRESSURE DETECTOR

(71) Applicant: TAI-LANG WU, TAIPEI CITY (TW)

(72) Inventor: TAI-LANG WU, TAIPEI CITY (TW)

(21) Appl. No.: 18/384,886

(22) Filed: Oct. 30, 2023

(30) Foreign Application Priority Data
Nov. 9, 2022 (TW) 111142772

(51) Int. Cl. B60C 23/04

(52) U.S. Cl. CPC B60C 23/044; B60C 23/0454; B60C 23/0479

(57) ABSTRACT

A mobile reader for waking up a tire pressure detector by using 2.4G signal encoding includes a reader MCU electrically connected to a reader memory unit, a reader high-frequency transceiver module, a reader main controller, and a reader input/output module. The reader MCU does not include a reader low-frequency circuit or a reader low-frequency antenna. The low frequency being less than or equal to 150 KHz. A display unit is electrically connected to the reader input/output module. A keyboard is electrically connected to the reader input/output module. This invention eliminates the need for using both high-frequency antennas and low-frequency antennas simultaneously to eliminate the issue of the excessive variety of antennas used in conventional tire pressure detection systems.

### FIELD OF THE INVENTION

The present invention relates to a mobile reader that wakes up a tire pressure detector by using 2.4G signal encoding. The unique feature of this invention is the use of high-frequency signals to trigger the TPMS (Tire Pressure Monitoring System) reader, allowing it to pair with tire pressure detectors operating with 2.4G signal encoding, thus reducing the variety of antennas required. securing device, and more particularly, to a.

### BACKGROUND OF THE INVENTION

A tire pressure is a critical value for the safe operation of a vehicle. With advancements in technology, methods for measuring tire pressure have significantly evolved. It has transitioned from manual measurement of each wheel before hitting the road to the automatic measurement and transmission of tire pressure values to a monitoring screen using various electronic devices, making it much more convenient.

For a complete tire pressure monitoring system, at least one tire pressure detector needs to be installed on each wheel, and the vehicle's main system should be equipped with a monitoring data device. Since the vehicle's wheels rotate at high speeds during operation, it is not suitable for wired communication between the tire pressure detectors and the monitoring data device. Instead, wireless signal transmission is preferred. As of now, the common approach is illustrated in FIG. 3, where the monitoring data reader and TPMS are equipped with high-frequency antennas, low-frequency antennas, BLE control circuits, and low-frequency control circuits. The operation process involves using the low-frequency antenna to transmit a signal that triggers the TPMS. Once awakened, the TPMS immediately reads voltage, temperature, pressure, and other data, responding to this data using the BLE radio frequency control circuit. The data is then received and displayed by the low-frequency trigger reader.

However, conventional tire pressure detection systems suffer from an issue of using a wide variety of antennas. For example, one TPMS system includes a high-frequency antenna and a low-frequency antenna, and for a vehicle with four wheels, it results in a total of eight antennas (four high-frequency and four low-frequency antennas). This setup undoubtedly places a significant burden on signal transmission. The present invention intends to provide a mobile reader for waking up a tire pressure detector by using 2.4G signal encoding to eliminate the shortcomings mentioned above.

### SUMMARY OF THE INVENTION

The present invention relates to a mobile reader for waking up a tire pressure detector by using 2.4G signal encoding includes a reader MCU electrically connected to a reader memory unit, a reader high-frequency transceiver module, a reader main controller, and a reader input/output module. The reader MCU does not include a reader low-frequency circuit or a reader low-frequency antenna. The low frequency being less than or equal to 150 KHz. A display unit is electrically connected to the reader input/output module. A keyboard is electrically connected to the reader input/output module.

The present invention uses a configured reader high-frequency input/output module. With this configuration, the present invention utilizes high-frequency signals to transmit signals to the matched tire pressure detectors that is awakened by using 2.4G signal encoding. As a result, the present invention only requires a reader high-frequency antenna, and the matched tire pressure detectors that is awakened by using 2.4G signal encoding only need to be equipped with a TPMS high-frequency antennas. There is no need to simultaneously use high-frequency and low-frequency antennas. The invention indeed improves the issue of excessive variety in antenna usage.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 illustrates a schematic diagram of the practical application system of the present invention;

FIG. 2 illustrates use of the practical application system of the present invention, and

FIG. 3 shows a conventional tire pressure detection system.

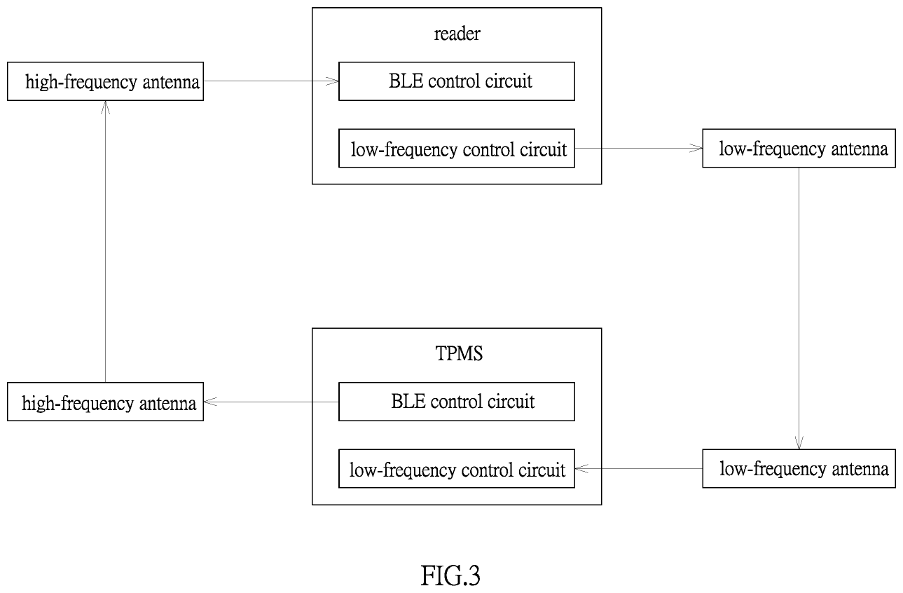

### DETAILED DESCRIPTION OF THE PREFERRED EMBODIMENT

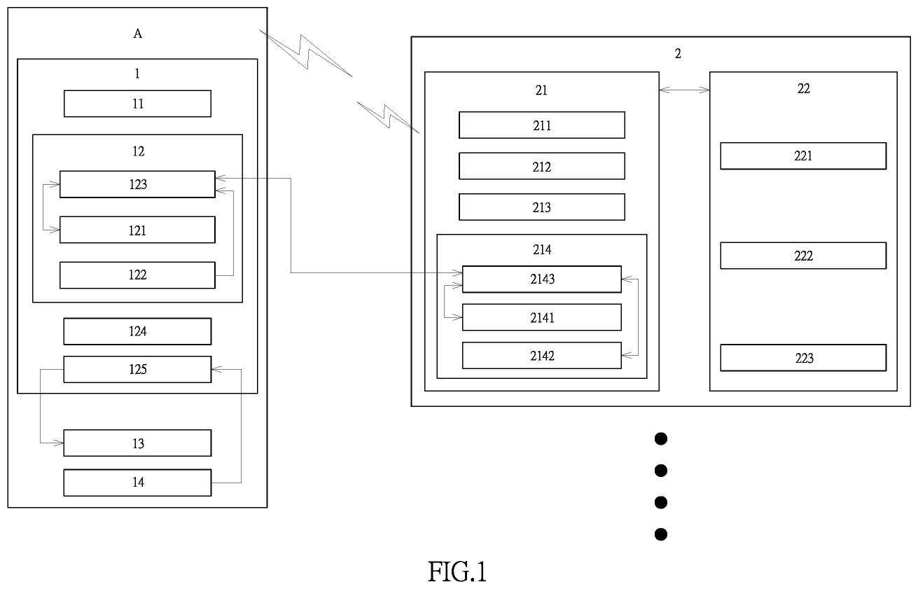

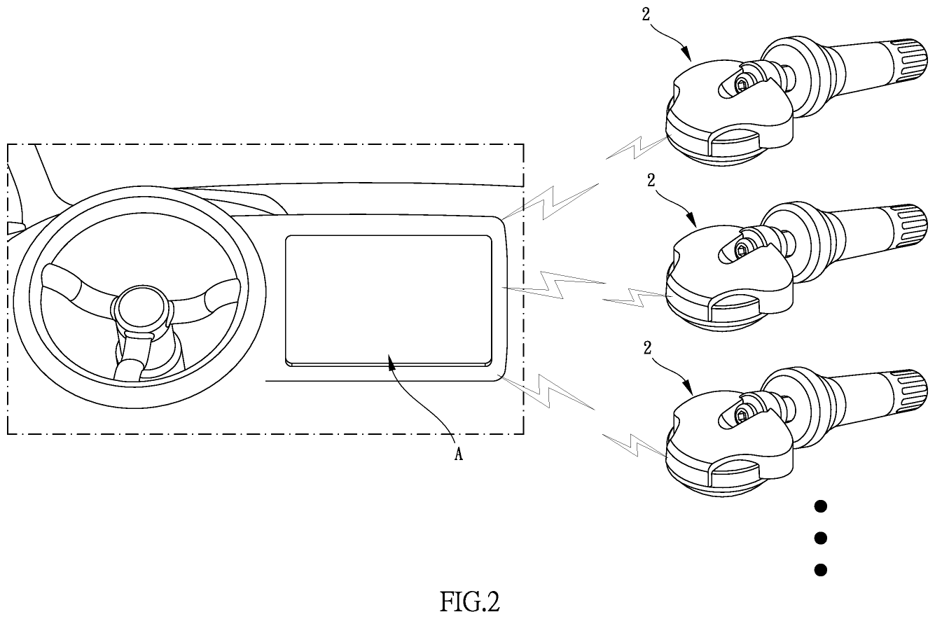

Referring to FIGS. 1 and 2, the mobile reader “A” that wakes up a tire pressure detector by using 2.4G signal encoding of the present invention comprises a reader MCU 1 (microcontroller) electrically connected to a reader memory unit 11, a reader high-frequency transceiver module 12, a reader main controller 124, and a reader input/output module 125. The reader high-frequency transceiver module 12 includes a reader BLE radio frequency unit 121, a reader OOK radio frequency unit 122, and a reader high-frequency antenna 123. The reader BLE radio frequency unit 121, the reader OOK radio frequency unit 122, and the reader high-frequency antenna 123 use a shared circuit.

The reader MCU 1 does not include a reader low-frequency circuit or a reader low-frequency antenna, with the low frequency being less than or equal to 150 KHz. A display unit 13 is electrically connected to the reader input/output module 125. A keyboard 14 is electrically connected to the reader input/output module 125.

The signal transmission modes of the reader high-frequency transceiver module 12 is one of BLE (Bluetooth Low Energy), OOK (On-Off Keying), RFID (Radio Frequency Identification), WI-FI, UWB (Ultra-wideband), Zigbee (Zonal Intercommunication Global-standard), and LPWAN (Low-Power Wide-Area Network).

The reader memory unit 11 is used to store user settings.

The reader main controller 124 is used to coordinate signal transmission and operation between all components within the reader MCU 1.

The present invention uses a configured reader high-frequency transceiver module 12 with a reader OOK radio frequency unit 122. With this configuration, the present invention utilizes the reader OOK radio frequency unit 122 to transmit signals to the matched tire pressure detectors 2 that can be awakened by using 2.4G signal encoding. Therefore, the present invention only requires the installation of a reader high-frequency antenna 123. Similarly, the matched tire pressure detectors 2 that is awakened by using 2.4G signal encoding also only need to install TPMS high-frequency antennas 2143. There is no need for simultaneous use of high-frequency and low-frequency antennas. Accordingly, the present invention indeed improves the issue of excessive variety in antenna usage.

In one embodiment, the tire pressure detector 2 that can be awakened by using 2.4G signal encoding is provided here. The tire pressure detector 2 mentioned above is an RF OOK-triggered tire pressure detector 2 that can be awakened using 2.4G by signal encoding, and it comprises a first TPMS-MCU 21 electrically connected to a first TPMS memory unit 211, a first TPMS communication interface 212, a first TPMS main controller 213, and a TPMS high-frequency transceiver module 214. The TPMS high-frequency transceiver module 214 includes a TPMS-BLE radio frequency unit 2141, a TPMS-OOK radio frequency unit 2142, and a TPMS high-frequency antenna 2143. The TPMS-BLE radio frequency unit 2141, the TPMS-OOK radio frequency unit 2142, and the TPMS high-frequency antenna 2143 use a shared circuit. A second TPMS-MCU 22 is electrically connected to a second TPMS memory unit 221, a second TPMS communication interface 222, a second TPMS main controller 223, and the first TPMS-MCU 21.

Both the first TPMS-MCU 21 and the second TPMS-MCU 22 do not include TPMS low-frequency circuitry or TPMS low-frequency antennas. The low frequency being less than or equal to 150 KHz.

The first TPMS memory unit 211 and the second TPMS memory unit 221 are used to store information related to the pairing with the present invention.

The first TPMS communication interface 212 and the second TPMS communication interface 222 are used for data transmission between the various units of the first TPMS-MCU 21 and the second TPMS-MCU 22.

The first TPMS main controller 213 is used to coordinate signal transmission and operation between the various components inside the first TPMS-MCU 21.

The second TPMS main controller 223 is used to coordinate signal transmission and operation between the various components inside the second TPMS-MCU 22.

The present invention can utilize the reader OOK radio frequency unit 122 to awaken the matched tire pressure detectors 2 that can be awakened by using 2.4G signal encoding. The tire pressure detectors 2 that can be awakened by using 2.4G signal encoding respond to their data using radio frequency signals. The present invention receives the TPMS feedback signal through the reader OOK radio frequency unit 122 and displays it on the display unit 13. The keyboard 14 provides control over the operation and triggering actions of the present invention.

The signal from the reader OOK radio frequency unit 122 can be a specific encoded OOK signal and is also a radio frequency signal. It shares the reader high-frequency antenna 123 with the reader BLE radio frequency unit 121 and can omit the reader low-frequency circuitry and reader low-frequency antenna. The reader OOK radio frequency unit 122 transmits a specifically encoded OOK signal, and upon receiving the radio frequency OOK trigger signal, the first TPMS-MCU 21 immediately informs the second TPMS-MCU 22 to read voltage, temperature, pressure, and other data, and then sends this data back to the first TPMS-MCU 21. It is then conveyed to the present invention via the TPMS high-frequency transceiver module 214 for reception and display. This approach allows for the omission of TPMS low-frequency circuitry and TPMS low-frequency antennas. Consequently, when a vehicle is equipped with four tire pressure detectors 2 that can be awakened by using 2.4G signal encoding, only four TPMS high-frequency antennas 2143 are needed. This is a significant reduction compared to traditional designs with eight antennas, resulting in fewer types of antennas and peripheral circuits. This approach reduces the signal transmission burden and lowers costs, making the product more competitive in sales.

The 2.4G signal encoding mentioned in the specification represents the transmission frequency of the reader OOK radio frequency unit 122 and the TPMS-OOK radio frequency unit 2142. While we have shown and described the embodiment in accordance with the present invention, it should be clear to those skilled in the art that further embodiments may be made without departing from the scope of the present invention.

What is claimed is:

1. A mobile reader for waking up a tire pressure detector using 2.4G signal encoding, comprising:
a reader MCU (1) electrically connected to a reader memory unit (11), a reader high-frequency transceiver module (12), a reader main controller (124), and a reader input/output module (125), the reader MCU (1) does not include a reader low-frequency circuit or a reader low-frequency antenna, the low frequency being less than or equal to 150 KHz;
a display unit (13) electrically connected to the reader input/output module (125), and
a keyboard (14) electrically connected to the reader input/output module (125).

2. The mobile reader as claimed in claim 1, wherein the reader high-frequency transceiver module (12) comprises a reader BLE radio frequency unit (121), a reader OOK radio frequency unit (122), and a reader high-frequency antenna (123), the reader BLE radio frequency unit (121), the reader OOK radio frequency unit (122), and the reader high-frequency antenna (123) use a shared circuit.

3. The mobile reader as claimed in claim 1, wherein a signal transmission modes of the reader high-frequency transceiver module (12) is one of BLE (Bluetooth Low Energy), OOK (On-Off Keying), RFID (Radio Frequency Identification), WI-FI, UWB (Ultra-wideband), Zigbee (Zonal Intercommunication Global-standard), and LPWAN (Low-Power Wide-Area Network).
